(19) United States
(12) Patent Application Publication
(10) Pub. No.: US 2007/0217612 A1
(43) Pub. Date: Sep. 20, 2007

(54) Method and system of key-coding a video

(76) Inventor: Vincent So, Ottawa (CA)

Correspondence Address: SMART & BIGGAR;P.O. BOX 2999, STATION D, 900-55 METCALFE STREET, OTTAWA, ON, K1P5Y6, US

(21) Appl. No.: 11/640,881

(22) Filed: Dec. 19, 2006

Related U.S. Application Data
(60) Provisional application No. 60/783,023, filed on Mar. 17, 2006.

(51) Int. Cl. H04L 9/00

(52) U.S. Cl. 380/277

(57) ABSTRACT

A system and a method for encrypting sections of a video with a sequence of encrypt keys and generating a plurality of sequences of decrypt keys of varying perfection are provided. The sequencing of the decrypt keys of varying perfection is key-coded to watermark the decrypted video so that the source of pirated copies of the video may be traced. Application of the system and method for the purposes of advance screening, digital cinema distribution, video service-network content distribution including broadcast services, on-demand services and pay-per-view services are also provided.

### RELATED APPLICATION

This application claims the benefit of prior U.S. provisional application No. 60/783,023 filed Mar. 17, 2006, hereby incorporated by reference in its entirety.

### FIELD OF THE INVENTION

The invention relates to methods and systems for preventing video piracy.

### BACKGROUND OF THE INVENTION

In the context of video pirating, cryptography serves its purpose as long as senders, receivers and attackers are distinct parties. When a few of the recipient customers become attackers, it fails miserably. Once the attacker has the keys as well as the encrypted file, the content is easily extracted.

### SUMMARY OF THE INVENTION

In one aspect of the present invention, there is provided a method comprising: encrypting each of a plurality of sections of a video with a respective encrypt key from a sequence of encrypt keys; for each encrypt key defining a respective set of at least one decrypt key, at least some of the sets containing at least two decrypt keys of varying perfection; generating a plurality of sequences of decrypt keys that correspond to the sequence of encrypt keys, each sequence comprising a respective decrypt key from each set of at least one decrypt key, the keys from sets containing at least two decrypt keys being selected to encode information specific to that sequence of decrypt keys.

In some implementations, every set of at least one decrypt key comprises two keys of varying perfection consisting of a perfect key and an imperfect key.

In some implementations, encrypting the video comprises encrypting sign bits of parameters representing the video.

In some implementations, each section of the video is a group of frames.

In some implementations, encrypting each group of frames comprises encrypting sign bits of parameters representing the group of frames.

In some implementations, each key is a bit sequence, and encrypting comprises xoring the bit sequence with bits representing the section of the video.

In some implementations, the information specific to that set of decrypt keys comprises at least one of end user identification information; cinema identification information; time stamp; IP address, computer ID.

In some implementations, the method further comprises decrypting each of the encrypted plurality of sections of the video with a respective decrypt key of one of the sequences of decrypt keys to form a decrypted plurality of sections of the video and displaying the decrypted plurality of sections of the video with sub-framing to prevent analog pirating.

In some implementations, the method according to the present invention further comprises streaming one of said sequence of decrypt keys in real time to a receiver for use in reproducing the video.

In another aspect of the present invention, there is provided a computer readable medium having computer executable instructions stored thereon implementing the method according to the present invention.

In still another aspect of the present invention, there is provided a system comprising: an encryptor for encrypting each of a plurality of sections of a video with a respective encrypt key from a sequence of encrypt keys, for each encrypt key there being defined a respective set of at least one decrypt key, at least some of the sets containing at least two decrypt keys of varying perfection; a key set generator that generates a plurality of sequences of decrypt keys that correspond to the sequence of encrypt keys, each sequence comprising a respective decrypt key from each set of at least one decrypt key, the keys from sets containing at least two decrypt keys being selected to encode information specific to that sequence of decrypt keys.

In yet another aspect of the present invention, there is provided a method comprising: obtaining an encrypted video comprising a plurality of encrypted video sections each encrypted with a respective encrypt key from a sequence of encrypt keys; accessing an encrypt key storage to provide identification information; receiving a key-coded sequence of decrypt keys encoded with information specific to the identification information; and decrypting each encrypted video section with a respective decrypt key from the sequence of decrypt keys, thereby watermarking the decrypted video.

In some implementations, the method further comprises displaying the decrypted video.

In some implementations, displaying the decrypted video comprises displaying the decrypted video with sub-framing.

In some implementations, receiving a key-coded sequence of decrypt keys comprises receiving the key-coded sequence of decrypt keys by key-streaming.

In some implementations, obtaining an encrypted video comprises obtaining the encrypted video by any one of: downloading the encrypted video over a file-sharing network; receiving a stream comprising the plurality of encrypted video sections and the key-coded sequence of decrypt keys; and obtaining a physical storage medium on which the encrypted video is recorded.

In some implementations, the method further comprises paying a per-viewing charge prior to receiving the key-coded sequence of decrypt keys.

In some implementations, the information specific to the identification information comprises at least one of end user identification information; cinema identification information; time stamp; IP address, computer ID.

In a further aspect of the present invention, there is provided a video decryption apparatus operable to carry out one of the methods described above.

In still a further aspect of the present invention, there is provided a video decryption system comprising: an encrypted video storage operable to store an encrypted video comprising a plurality of encrypted video sections each encrypted with a respective encrypt key from a sequence of encrypt keys; and a decryptor functionally connected to the encrypted video storage and operable to: access an encrypt key storage to provide identification information; receive a key-coded sequence of decrypt keys encoded with information specific to the identification information; and decrypt each encrypted video section with a respective decrypt key from the sequence of decrypt keys, thereby watermarking the decrypted video.

In one embodiment a previewer video decryption system comprises the video decryption system described above, wherein the encrypted video storage comprises any one of a DVD, a hard drive and a memory.

In some implementations of the previewer video decryption system, the decryptor is operable to receive the key-coded sequence of decrypt keys by key-streaming.

In some implementations, the previewer video decryption system further comprises display equipment functionally connected to the decryptor and operable to display the decrypted video with sub-framing.

In another embodiment, a digital cinema video decryption system comprises: a digital projector; a cinema server; and a screen controller, wherein the screen controller is functionally connected to the digital projector and comprises the video decryption system described above, and wherein the cinema server is functionally connected to the screen controller and is operable to receive an encrypted video and send the encrypted video to the screen controller.

In some implementations of the digital cinema video decryption system, the screen controller is operable to receive the key-coded sequence of decrypt keys by key-streaming.

In some implementations of the digital cinema video decryption system, the screen controller and the digital projector are operable to display the decrypted video with sub-framing.

In still another embodiment, a video service network video decryption system comprises: the video decryption system described above, wherein the video service network video decryption system is operable to receive the key-coded sequence of decrypt keys by receiving a stream comprising the key-coded sequence of decrypt keys and the plurality of encrypted video sections.

In some implementations of the video service network video decryption system, the video service network video decryption system deletes each decrypt key of the key-coded sequence of decrypt keys after the decrypt key has been used to decrypt a corresponding section of the plurality of encrypted video sections.

In some implementations of the video service network video decryption system, the video service network video decryption system comprises at least one of a mobile terminal with a screen display and a set-top box.

In some implementations of the video service network video decryption system, the set-top box has a built in DVD player.

In some implementations of the video service network video decryption system, the video decryption system is operable to display decrypted video with sub-framing.

In yet another embodiment, a video service network video decryption system comprises: the video decryption system described above, wherein the video service network video decryption system forms part of a file-sharing network, wherein the video service network video decryption system is operable to share the encrypted video across the at least one file-sharing network with other video service network video decryption systems which are part of the file-sharing network.

In some implementations of the video service network video decryption system, the video service network video decryption system comprises any one of a mobile terminal with a screen display, a DVD player, a personal video recorder, and a computer.

In some implementations of the video service network video decryption system, the video service network video decryption system is operable to receive the key-coded sequence of decrypt keys by key-streaming.

In some implementations of the video service network video decryption system, the video service network video decryption system is operable to display decrypted video with sub-framing.

In some implementations of the video service network video decryption system, the video service network video decryption system is further operable to receive the key-coded sequence of decrypt keys by receiving a stream comprising the key-coded sequence of decrypt keys and the plurality of encrypted video sections from a service provider.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a schematic diagram of an arrangement of encrypted video streaming components;

FIG. 2 is a process diagram of an encoding process in accordance with an embodiment of the invention;

FIG. 3 is a schematic diagram of an example of a screeners preview video delivery system according to an embodiment of the invention;

FIG. 4 is a schematic diagram of an example of a digital cinema video delivery system according to an embodiment of the invention;

FIG. 5 is a schematic diagram of an example of a video service network video delivery system according to an embodiment of the invention;

FIG. 6 is a schematic diagram of an example of a video service network video delivery system according to an embodiment of the invention;

FIG. 7 is a flowchart of an example of a method of key-coding according to an embodiment of the invention;

FIG. 8 is a flowchart of an example of a method of delivering video to a preview screener according to an embodiment of the invention;

FIG. 9 is a flowchart of an example of a method of delivering video to a digital cinema according to an embodiment of the invention;

FIG. 10 is a flowchart of an example of a method of delivering video to video service network subscribers according to an embodiment of the invention; and

FIG. 11 is a flowchart of an example of a method of delivering video to pay-per-view customers according to an embodiment of the invention.

### DETAILED DESCRIPTION OF EMBODIMENTS

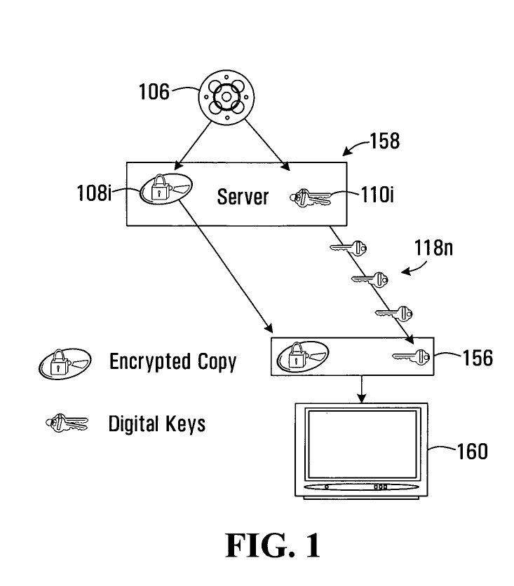

A partial solution to the piracy problem is to employ key-streaming such as taught in applicant's co-pending U.S. application Ser. No. 10/702,540 entitled “Internet Based video and Music Rental System And Method” hereby incorporated by reference in its entirety. Key-streaming technology addresses the problem by not letting the attackers have all the keys at the same time. The video file is encrypted with multiple keys. Different parts of the video are encrypted with different digital keys. Prior to viewing, the encrypted videos are obtained and stored in a storage device such as hard drive or videodisks. To view the video, the viewer has to log onto the server and retrieve the keys in real time from the server. Once the server has verified the viewer ID, the first digital key, which enables the customer to unlock the first part of the file, is transmitted to the viewer. The user may start enjoying the first section of the video. When it reaches the second section, the next corresponding key will be transmitted and the previous key will be deleted. The user always only has the key to unlock the current section and no digital key is stored in the permanent memory of the user's computer. The viewing process is monitored and the appropriate key will be sent at the appropriate time, allowing seamless viewing of the video. See FIG. 1 for an example of this.

In the example implementation shown in FIG. 1, an encrypted copy 108i of a video 106 is created by encrypting each section of the video 106 with a respective encrypt key of a set of encrypt keys 110i. The encrypted copy 108i and the set of encryption keys 110i are stored by a service provider 158. A consumer's video storage equipment 156 has a first communication link with the service provider 158, over which the consumer can then obtain the encrypted video 108i from the service provider 158. Alternatively, the encrypted video may be provided to the consumer on a physical storage medium, for example a DVD or a memory. The consumer's video storage equipment 156 has a second communication link with the service provider 158, over which the video storage equipment 156 receives the streamed individual decryption keys 118n in sync with the video. In this implementation, the decryption keys 118n which are received over the communication link with the service provider 158 are identical to the respective encryption keys 110i used to encrypt the video 106. The video storage equipment 156 is functionally connected to the consumer's video display equipment 160, which, in the example implementation of FIG. 1, is shown as a television.

According to an embodiment of the invention, a key-coding method is provided that allows information to be encoded into keys used to encrypt a sequence of frames of a video. Key-coding can be used to build upon the above-described key-streaming capability, but it is to be understood that it can be applied to other contexts as well.

The video is encrypted with a set of keys (PERFECT-KEYS) with which the encrypted video can be decrypted and recovered without any error. A set of IMPERFECT-KEYS is derived from the set PERFECT-KEYS. The IMPERFECT-KEYS decrypt and reproduce the picture with negligible but detectable imperfections, e.g. a minute difference in colour. In providing a sequence of keys for use in decrypting the encrypted video, for example when streaming the keys to the viewer, information is coded in the key sequence. More specifically, a respective key is selected for each of the set of keys required to decrypt the video. Each key is either a key from the set of PERFECT-KEYS (which, for example, represents “1”) or the corresponding key form the set of IMPERFECT-KEYS (which, for example, represents “0”). The sequence of perfect and imperfect keys codes for the information.

In some embodiments, information, such as viewer ID, and time of viewing are coded in the key sequence in real time during the viewing process by sending different keys representing a string of 1s and 0s. This process effectively watermarks the video with the viewer ID and other the pertinent information in real time.

If the movie is being pirated, the encoding allows the later identification of the source from an illegal copy. More than one set of “imperfect” keys can be derived from the set of “perfect” keys and multi-level coding can be implemented. The coded information can be recovered by comparing the illegal copy with the original. For example, in some implementations, the modified frame represents “0” and unmodified frame represents “1”.

Any method of encoding information can be employed. The coding may be binary coding that employs a sequence of 1s and 0s or multi-level coding that uses more than two levels e.g. a three level coding scheme with 0's, 1's and 2's. The code sequence may be like (210221001021 . . . ).

In the above-described embodiment, it is assumed that there are two sets of keys, namely a set of perfect keys and for each perfect key a corresponding imperfect key. More generally, for each of the encrypt keys there will be a corresponding set of at least one decrypt key, but at least some of the sets will contain two decrypt keys of varying perfection. In other words, not necessarily all of the decrypt keys will have multiple versions. Then, when information is encoded into the sequence of decrypt keys, this encoding will be done by selecting the appropriate decrypt keys from the sets that contain multiple decrypt keys. In a specific example, every second encrypt key may have a corresponding set of two decrypt keys that contain a perfect and imperfect key. Furthermore, a given set of decrypt keys for a given encrypt key may have multiple imperfect versions. This would only be useful if there was some visibly perceptible difference between the decrypted images that would be produced using the different keys.

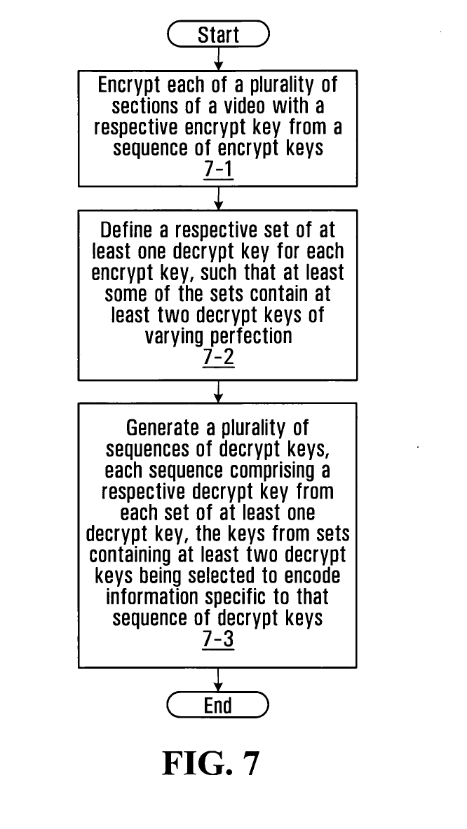

An example of a method of key-coding a video will now be described with reference to FIG. 7. The method begins at step 7-1, in which each of a plurality of sections of a video are encrypted with a respective encrypt key from a sequence of encrypt keys. In step 7-2, a respective set of at least one decrypt key is defined for each encrypt key in the sequence of encrypt keys, such that at least some of the sets contain at least two decrypt keys of varying perfection. In step 7-3, a plurality of sequences of decrypt keys are generated, such that each sequence of decrypt keys comprises a respective decrypt key from each set of at least one decrypt key, wherein for each sequence of decrypt keys, the keys from the decrypt key sets that contain at least two decrypt keys are selected to encode information specific to that sequence of decrypt keys.

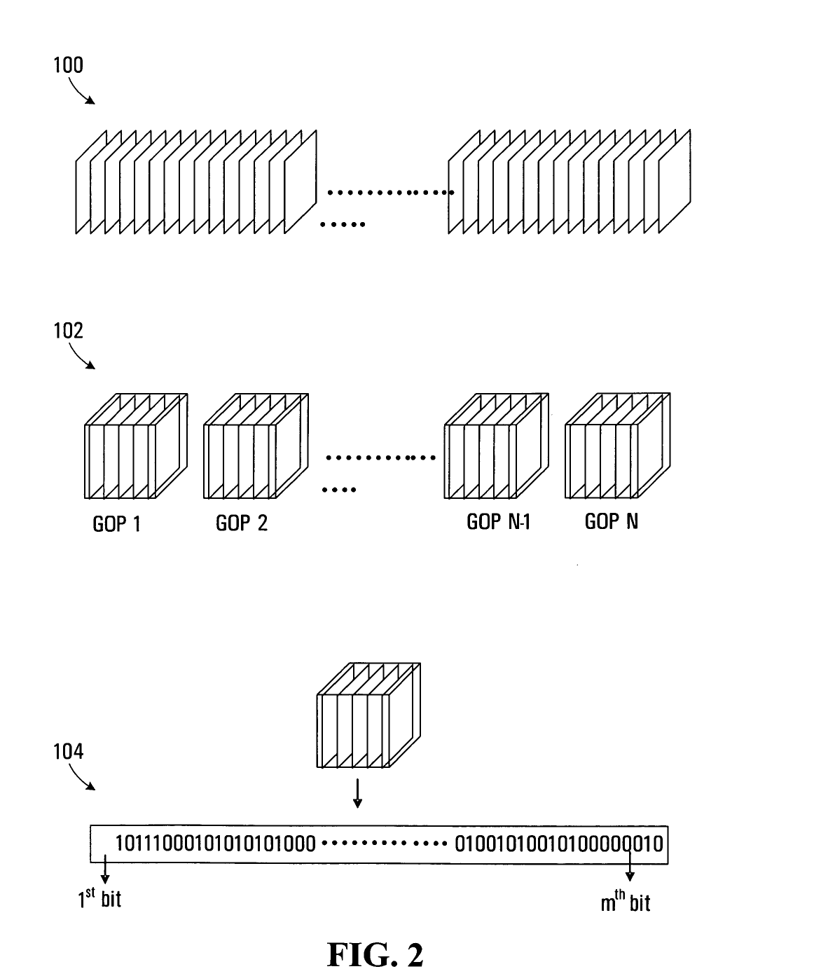

A detailed example implementation will now be described with reference to FIG. 2. In this example a video is composed of a long sequence of pictures 100. In one embodiment of the invention, to keep the file size more manageable, the video is encoded and compressed. During the encoding process pictures are grouped together in groups and the video then becomes a sequence of Group Of Pictures (GOPs) 102.

Each GOP is then encoded and compressed into a bit stream of m bits of 1's and 0's 104. In other words, GOP p=p₁ p₂ . . . pₘ₋₁ pₘ, where pᵢ represents either “1” or “0”.

For each GOP, an encrypt key (k), is generated for example by randomly generating a bitstream of length m which can be represented as k=b₁b₂ . . . bₘ.

An encryption function (Eₖ) can then be defined as follows:

Eₖ(p)=(b₁ [symbol] p₁)(b₂ [symbol] p₂) . . . (bₘ₋₁ [symbol] pₘ₋₁)(bₘ [symbol] pₘ)

where [symbol] is the binary XOR operation and has the following properties:

| XOR | 1 | 0 |
|---|---|---|
| 1 | 0 | 1 |
| 0 | 1 | 0 |

The decrypt key would be the same as the encrypt key and the decrypt function is the same as the encrypt function. The PERFECT-KEY would be k.

Let j be the position of one of the least-significant-bits in the GOP bit stream. An IMPERFECT-KEY can be generated by replacing bⱼ with bⱼ′ and bⱼ′=1 [symbol] bⱼ. In other words, a bit in the PERFECT-KEY corresponding to one of the least significant bits in the GOP is inverted. In some embodiments, the inversion is applied to the least significant bit. This makes the following transformation:

PERFECT-KEY, k=b₁b₂·bⱼ . . . bₘ₋₁bₘ

→

IMPERFECT-KEY, k′=b₁b₂·bⱼ′ . . . bₘ₋₁bₘ

When the GOP is decrypted with the PERFECT-KEY, there is no error. If the GOP is decrypted with the IMPERFECT-KEY an error will be introduced. The error is negligible to the eye because the error is introduced only to one of the least-significant-bits. However, the error should be detectable by comparing the degraded picture to the perfect picture. Multiple bits can be inverted if the picture quality degradation that results is acceptable.

The set of PERFECT-KEYS is made up of all the k's for the GOPs making up a movie and the corresponding set of IMPERFECT-KEYS is made up of all the k's. In streaming the decrypt keys to the viewer, information, can be coded in the key sequence in real time by selecting different keys from the two sets of keys.

As it was shown by Shi, C. and B. Bhargava: 1998, “A Fast MPEG Video Encryption Algorithm”. In Proceedings of the 6th ACM International Multimedia Conference, Bristol, UK pp. 81-88, it is not necessary to encrypt all the bits that represent a video. It is sufficient just to encrypt only the sign bits in each of the GOP's bit stream.

In one embodiment of the invention, a sign bit encryption approach is employed to encrypt the sign bits representing a video, and the key coding method described above is applied to the associated keys. The sign bits are the bits that represent the sign of a parameter value, e.g. “1” represent “+” and “0” represents “−”. The particular parameters that will be present in a given GOP encoding are encoding specific. The particular methods described herein are not dependent upon the particular encoding technique employed.

For a given GOP, the bit stream is a string of values arrange in specific order, typically defined by a given encoding standard. Examples include MPEG (Moving Picture Experts Group) standards MPEG-1, MPEG-2 and MPEG-4. MPEG-2 is the DVD standard. Luminance and chrominance values are examples of parameters that are defined in the bit stream of the MPEG-2 DVD standard.

Let S be a bitstream of the sign bits of parameter values in a GOP bit stream as follows:

S=s₁s₂·sⱼ . . . sₙ₋₁sₙ

where sᵢ (i=1, 2, . . . ) are all of the sign bits of coefficients in an GOP bit stream and sⱼ the sign bit of a coefficient of a least significant term. A key, k, is a bitstream of length n which can be represented as k=b₁b₂·bⱼ . . . bₙ.

The encryption function Ek can be described as

Ek(S)=(b₁ [symbol] s₁) . . . (bⱼ [symbol] sⱼ) . . . (bₙ [symbol] sₙ)

### The decrypt key is the same as the encrypt key and the decrypt function is the same as the encrypt function.

PERFECT-KEY, k=b₁b₂·bⱼ . . . bₙ₋₁bₙ

→

IMPERFECT-KEY, k′=b₁b₂·bⱼ′ . . . bₙ₋₁bₙ, where bⱼ′=1\textcircled{x}bⱼ

In the examples described, encryption is applied to each group of frames using a respective key. More generally, the encryption is applied to a sequence of sections of the movie. Each section might be a single frame or multiple frames.

### Integrated Applications

In some embodiments, the key-coding method is employed to watermark a video in real time thereby allowing a pirated copy to be traced back to the perpetrator, in combination with other security measures to provide an integrated approach. Integrated applications of the key-coding method include decryptor and display systems that handle storing encrypted video, generating key-coded decrypt keys, decrypting the encrypted video with the key-coded decrypt keys and displaying the watermarked decrypted video. The other security measures include one or more of a sub-framing mechanism, and a key-streaming mechanism.

The sub-framing mechanism protects a video from being recorded by camcorder during exhibition in cinemas or being taped by a tape recorder as taught in applicant's co-pending U.S. application Ser. No. 11/079,222 entitled “Image Display Methods and Systems” and Ser. No. 11/248,420 entitled “Image Display Methods and Systems With Sub-frame Intensity Compensation” hereby incorporated by reference in their entirety. Sub-framing deters the recording of videos by camcorders in theatres. A frame is split into a number of sub-frames which are then displayed in sequence within a standard frame period. Each sub-frame does not have all the information of the frame, but the sum of all the sub-frames contains all the information. To the audience in the theatre, there is no difference, since seeing with one's eyes is a continuous process; whereas cam cording is a discrete process. The picture is taken and recorded frame by frame. It is almost impossible for each recorded frame to capture all its sub-frames. Hence the pirated copy is a poor quality copy and has no commercial value.

The key-streaming mechanism protects the digital content from being pirated as taught in applicant's co-pending U.S. application Ser. No. 10/702,540 entitled “Internet Based video and Music Rental System and Method” hereby incorporated by reference in its entirety. With key-streaming, a video file is encrypted with multiple keys. The encrypted file can be sent to the viewer by any means before viewing. To view the video, viewer has to retrieve the keys in real time from the servers. The viewing process is monitored and the appropriate keys are sent in sync with the video. The previous key is deleted. This process is secure since the viewer does not have all the keys at the same time.

With the three technologies combined, end-to-end protection for content can be provided. By applying appropriate combinations of the three technologies, the content can be protected in both analogue and digital forms. Also, by applying appropriate combinations of the three technologies to various steps and channels of a video's release, the video can be protected in every step and every channel of its release. In an example release sequence, a video might first be released to screeners, then theaters, TV channels and DVDs. The sequence may be different for different videos.

### Previewers

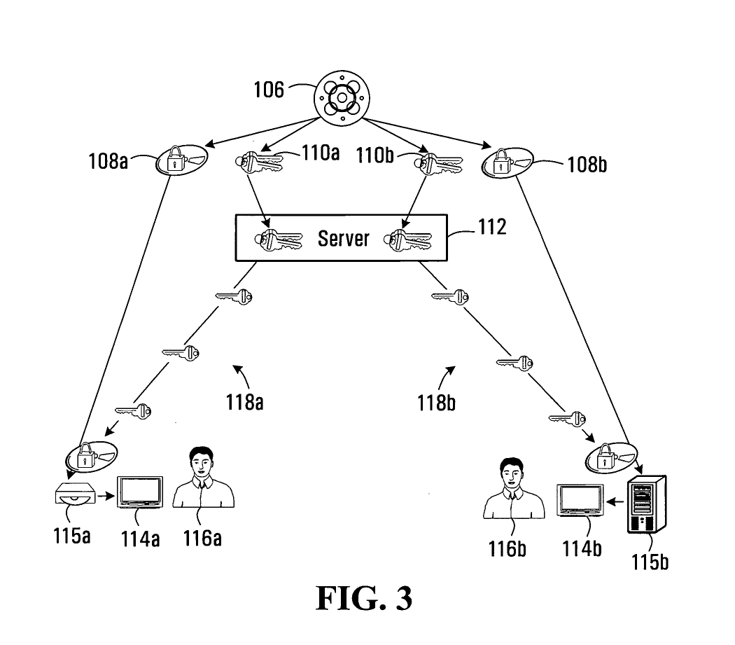

An embodiment of the invention provides a method of protecting copies of a video available for preview, for example by previewers such as critics. FIG. 3 shows an example implementation. Advance copies are made and each copy is encrypted individually with a set of keys. The keys are stored, for example in a key server. The encrypted copy is sent to the previewer by any appropriate means and is stored in an encrypted video storage, which, for example, may be on a DVD, a hard drive or a memory. Even if a hacker manages to get a copy of the encrypted file, it will take a long time to hack all the keys.

To view the movie, the previewer logs onto the key server, thereby providing identification information. The key server generates a previewer-specific set of modified keys based on the encrypt keys and the identification information and sends the modified keys to the previewer in sync with the video thereby watermarking the copy with the previewer ID using the key-coding method. Other information such as a time stamp, IP address and computer ID to name a few specific examples may also be encoded.

If the copy is being pirated, the copy can be traced back to a particular previewer. This process is secure because the only time the video can be pirated is during the viewing process and this should not be possible without the cooperation of the previewer.

In the example implementation shown in FIG. 3, two encrypted advance copies 108a and 108b of a video 106 are created with encryption key sets 110a and 110b respectively. The encryption key sets are stored on a key server 112, which has communication links with download and decryption systems 115a and 115b of previewers 116a and 116b respectively. The decrypt devices 115a and 115b are functionally connected to display devices 114a and 114b respectively. The encrypted copy 108a is sent to the previewer 116a on a physical storage medium, which is shown as a DVD in FIG. 3, while the encrypted copy 108b is sent over the internet to the previewer 116b. In general, the encrypted videos may be delivered to the download and decryption systems 115a and 115b by any appropriate delivery mechanism to be stored in any encrypted video storage that is capable of storing encrypted video data, for example a DVD, hard drive or memory.

In the example implementation shown in FIG. 3, the download and display devices 115a and 115b of the previewers 116a and 116b respectively are shown as a DVD player and a networked computer respectively. In general, a previewer's download and decryption system may comprise any combination of equipment, or a single piece of equipment, operable to store an encrypted video, retrieve a decryption key, and decrypt an encrypted video file so that the decrypted video may be displayed on a display device.

In operation, the video 106 is encrypted into the encrypted copies 108a and 108b with the encryption keys 110a and 110b respectively, and the encryption keys 110a and 110b are stored in an encrypt key storage on the key server 112. The encrypted copies 108a and 108b are sent to the previewers 116a and 116b and are stored in encrypted video storages which are part of the download and decryption systems 115a and 115b respectively. When the previewer 116a wishes to view the encrypted advance copy 108a, the previewer 116a logs in to the key server 112 to request a set of previewer-specific key-coded decryption keys 118a. The key server 112 generates the set of previewer-specific key-coded decryption keys 118a and then sends them to the download and decryption system 115a of the previewer 116a in sync with the video. The same method is used by the previewer 116b. When the previewer 116b wishes to view the encrypted advance copy 108b, the previewer 116b logs in to the key server 112 to request a set of previewer specific key-coded decryption keys 118b. The key server 112 generates the set of previewer specific key-coded decryption keys 118b and then sends them to the download and decryption system 115b of the previewer 116b in sync with the video. The download and decryption systems 115a and 115b, decrypt the encrypted advance copies 108a and 108b respectively, using the previewer-specific key-coded decryption keys 118a and 118b respectively, thereby watermarking the decrypted videos.

In some implementations, the download and display equipment 114a and 114b display the decrypted videos with sub-framing in order to deter the use of camcorders or other video recording devices to record the displayed video.

While FIG. 3 shows two encrypted copies and two previewers, in general encrypted advance copies of a video may be generated and sent to any number of previewers.

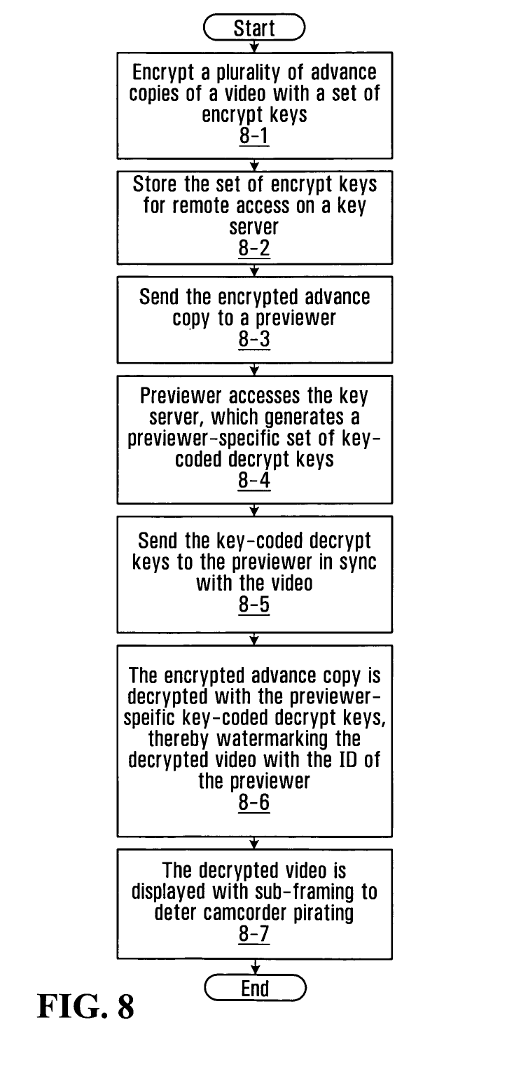

An example of a method of protecting copies of a video available for preview will now be described with reference to FIG. 8. The method begins at step 8-1, in which a plurality of copies of a video are encrypted with a set of encrypt keys. In step 8-2, the set of encrypt keys are stored for remote access. As stated above, in some implementations the set of encrypt keys are stored in a key server. In step 8-3, an encrypted advance copy of the video is sent to a previewer. In step 8-4, the previewer logs in to the key server, which generates a previewer-specific set of key-coded decrypt keys. In step 8-5, the previewer-specific key-coded decrypt keys are sent to the previewer in sync with the video. In step 8-6, the encrypted advance of the video is decrypted with the previewer-specific key-coded decrypt keys, thereby watermarking the decrypted video with the ID of the previewer. In step 8-7, the decrypted video is displayed with sub-framing to deter camcorder pirating.

### Digital Cinemas

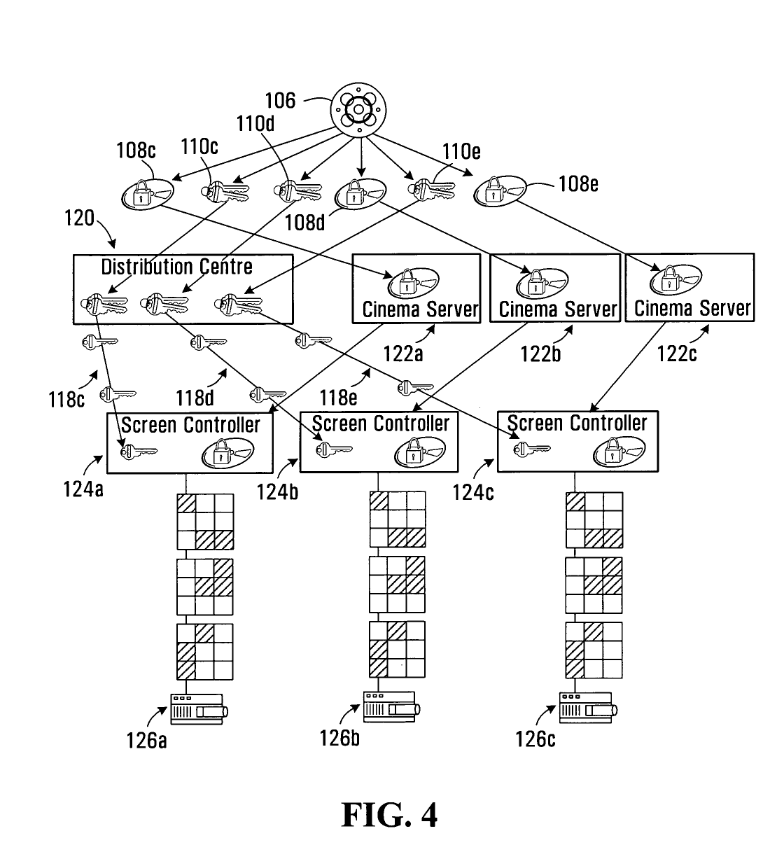

Another embodiment of the invention provides a method of making copies of videos available to digital cinemas. FIG. 4 shows an example implementation. Cinemas today use film projectors, but they are going to change to digital. The approaches described herein can distribute content to a digital cinema securely and cost effectively.

With the key-streaming method, video is encrypted with a set of keys. The encryption is different for each individual cinema. The encrypted files are then delivered to the cinemas by any appropriate mechanism and stored in an encrypted video storage. Even if the encrypted file were stolen, it would be almost impossible to hack. Once it is confirmed that the cinema has received the encrypted file, the set of encrypt keys is delivered to a distribution center. In some implementation, the set of encrypt keys are stored in a server at the distribution center. A cinema server receives the encrypted file and delivers it to appropriate screen computers where it is stored in the encrypted video storage. At show time, the screen computer logs onto the distribution center server to retrieve the keys and provide identification information. After authentication, the distribution center delivers the keys to the screen computer one at a time in sync with the movie and the previous key is deleted.

Using the key-coding method, the movie can be watermarked with cinema ID and show time. To deter bootlegging with camcorder, sub-framing can be implemented at the projector during exhibition. This distribution system is cost effective, offers end-to-end protection and has no single point vulnerability.

An example of a system for distributing encrypted copies of videos to digital cinemas and decrypting and displaying the videos will now be described with reference to FIG. 4. In the example implementation shown in FIG. 4, three encrypted copies 108c, 108d and 108e of a video 106 are created with encryption key sets 110c, 110d and 110e respectively. The encryption key sets 110c, 110d and 110e are stored in a distribution center 120, which has communication links with three screen controllers 124a, 124b and 124c. The three screen controllers 124a, 124b and 124c are functionally connected to digital projectors 126a, 126b and 126c respectively. The three encrypted copies 108c, 108d and 108e are transmitted to, and stored in, cinema servers 122a, 122b and 122c respectively. The cinema servers 122a, 122b and 122c have communication links with the screen controllers 124a, 124b and 124c respectively.

In the example implementation shown in FIG. 4, the decrypted videos are displayed with sub-framing by the digital projectors 126a, 126b and 126c. In general, any type of display device may be used to display the decrypted video, for example an LED screen.

In operation, the video 106 is encrypted into the encrypted copies 108c, 108d and 108e with the encryption key sets 110c, 110d and 110e respectively. The encrypted copies 108c, 108d and 108e are sent to the cinema servers 122a, 122b and 122c, respectively, by an appropriate delivery mechanism. For example, on a DVD or via a communication network such as the internet. Once the delivery of the encrypted copies 108c, 108d and 108e are confirmed, the encryption key sets 110c, 110d and 110e are stored in an encrypt key storage at the distribution center 120. The cinema servers 122a, 122b and 122c then deliver the encrypted copies 108c, 108d and 108c to the appropriate screen controllers, namely 124a, 124b and 124c respectively.

In some implementations, a cinema server distributes an encrypted copy of a video to more than one screen controller.

At showtime for a digital cinema associated with digital projector 126a, the screen controller 124a requests a set of screen-specific key-coded decryption keys 118c from the distribution center 120. The distribution center 120 then generates the set of screen-specific key-coded decryption keys 118c, which the distribution center 120 then sends to the screen controller 124a in sync with the video. The screen controller 124a decrypts the encrypted copy 108c using the screen-specific key-coded decryption keys 118c, thereby watermarking the decrypted video displayed by digital projector 126a. Screen controllers 124b and 124c use the same method for showtimes associated with digital projectors 126b and 126c respectively.

In some implementations, if the delivery of the encrypted copies was unsuccessful, for example if the delivery was interrupted, incomplete, corrupted or intercepted, and therefore the delivery cannot be confirmed, the first encryption key set will not be delivered to the distribution center 120. The video 106 will then be encrypted with a different set of encryption keys and the resulting encrypted copies will be delivered to the cinemas.

In some implementations, the screen controllers 124a, 124b and 124c control the digital projectors 126a, 126b and 126c to display the decrypted videos with sub-framing in order to deter the use of camcorders or other video recording devices to record the displayed video.

While FIG. 4 shows three encrypted copies and three digital cinemas, in general encrypted copies of a video may be generated and sent to any number of digital cinemas.

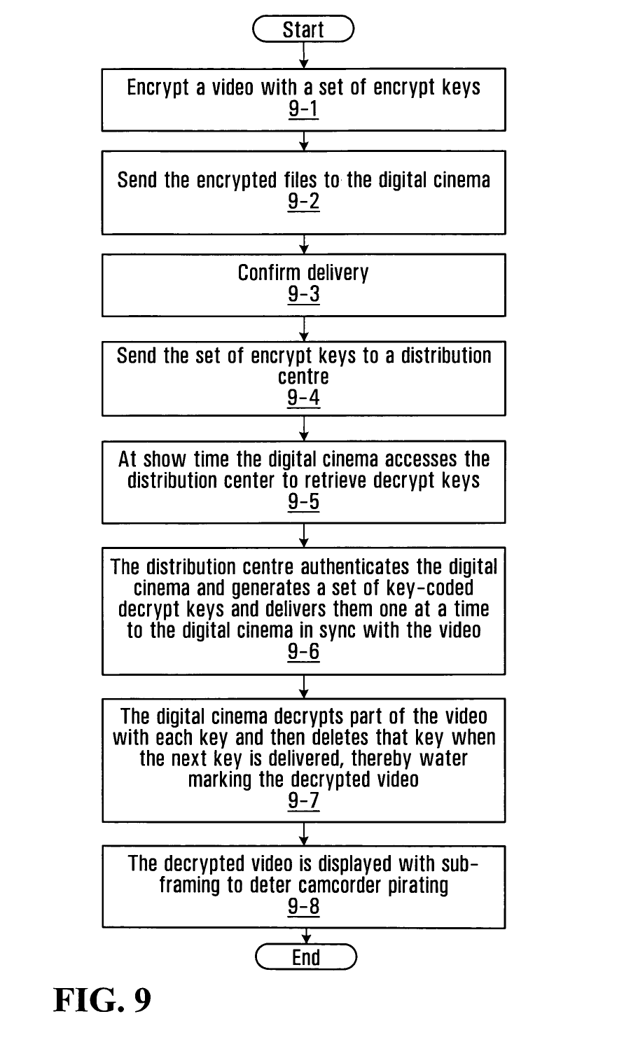

An example of a method of making copies of videos available to digital cinemas will now be described with reference to FIG. 9. The method begins at step 9-1, in which a video is encrypted with a set of encrypt keys. In step 9-2, the encrypted video file is sent to the digital cinema. In step 9-3, delivery of the encrypted video file is checked to confirm that the encrypted video file has been delivered. In step 9-4, the set of encrypt keys are sent to and stored in a distribution center. In step 9-5, at show time, the digital cinema accesses the distribution center to retrieve decrypt keys. In step 9-6, the distribution center authenticates the digital cinema, generates a set of key-coded decrypt keys and delivers the decrypt keys to the digital cinema one at a time in sync with the video. In step 9-7, the digital cinema decrypts part of the video with each key-coded decrypt key, thereby watermarking the decrypted video, and then deletes that key when the next key is delivered. In step 9-8, the decrypted video is displayed with sub-framing to deter camcorder pirating. In some implementations, if the delivery was unsuccessful, for example if the delivery was interrupted, incomplete, corrupted or intercepted, and therefore the delivery cannot be confirmed in step 9-3, the method will return to step 9-2 and the encrypted video will be sent to the digital cinema again.

In some implementations, if the delivery cannot be confirmed in step 9-3, the method will return to step 9-1 and the video will be encrypted with a different set of encrypt keys.

In some implementations, the encrypted video files that are sent to the digital cinema in step 9-2 are stored in a cinema server and at showtime in step 9-5, a screen controller will access the distribution center to retrieve the decrypt keys and will retrieve the encrypted files from the cinema server. In some implementations, the decrypted video will not be displayed with subframing.

### Video Service Network

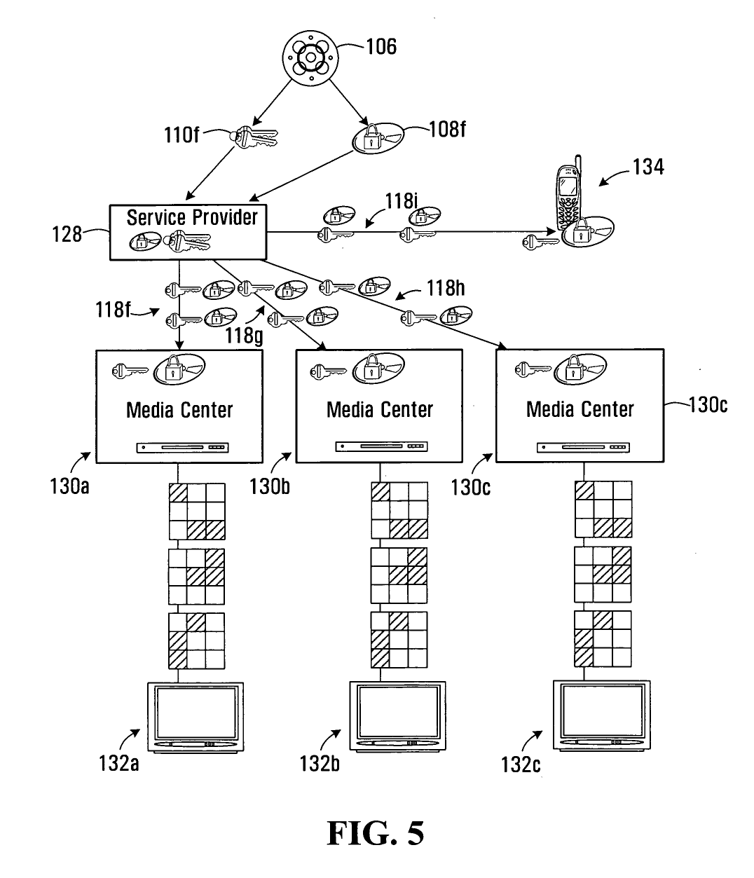

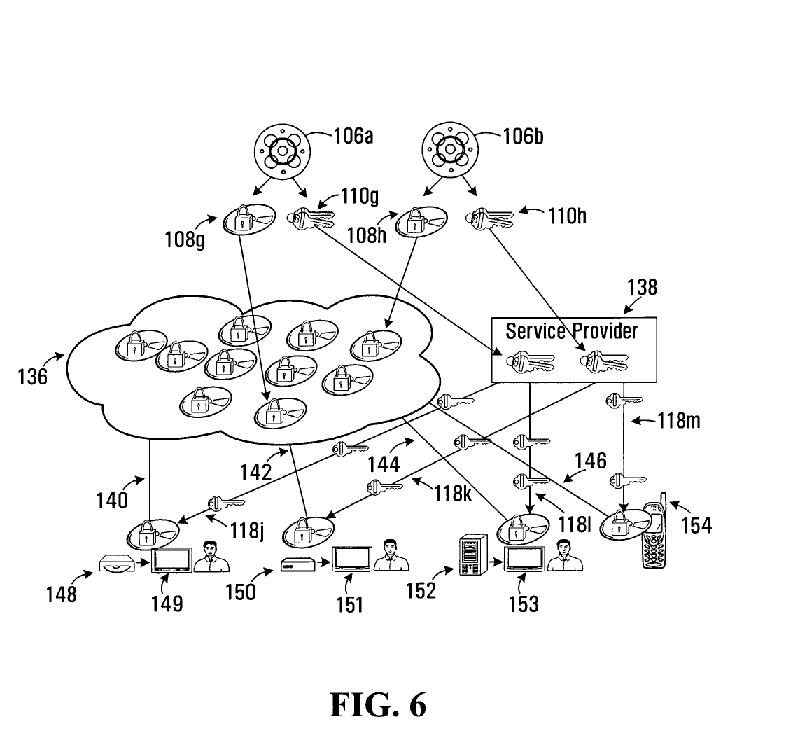

Another embodiment of the invention provides a mechanism of providing copies of videos to video service networks such as cable networks or satellite television networks. For video services, encrypted content is distributed to consumers in two primary schemes. In a first scheme, a service provider streams both the encrypted content and key-coded decrypt keys to consumers. In a second scheme, encrypted content is made freely available to file-sharing networks and/or on physical storage mediums such as DVDs. The consumer downloads the encrypted content from the file-sharing network or obtains the DVD and then contacts a service provider to retrieve key-coded decryption keys in order to decrypt the encrypted content. FIGS. 5 and 6 show example implementations of systems for implementing the first and second encrypted content distribution schemes respectively. In both schemes, download and decryption systems, for example media centers including set-top boxes with built-in DVD players, are used to retrieve the encrypted content and decrypt it for display. To view the encrypted content, consumers provide identification information to retrieve key-coded decrypt keys from their service provider via their download and decryption systems. The appropriate decrypt keys are then sent to the download and decryption systems of the consumers in order to decrypt the encrypted content. At the download and decryption system, sub-framing may be implemented to deter camcorder pirating and key-coding is used to watermark the copy.

The system can also be adapted to address the upcoming mobile video market by enabling encrypted content to be downloaded to the mobile phone and the keys to be retrieved via wireless networks.

FIG. 5 is a block diagram of an example implementation of a system for distributing encrypted content over a video service network, in which consumers receive both the encrypted content, and decryption keys for decrypting the encrypted content, from a service provider. In the example implementation shown in FIG. 5, an encrypted copy 108f of a video 106 is created with an encryption key set 110f. The encryption key set 110f and the encrypted copy 108f are stored by a service provider 128, which has communication links with a plurality of download and decryption systems, which are shown as media centers 130a, 130b and 130c and a mobile terminal 134. In some implementations, the media centers 130a, 130b and 130c include set-top boxes with built in DVD players. The media centers 130a, 130b and 130c are functionally connected to television displays 132a, 132b and 132c respectively, while the mobile terminal 134 is shown as a cellular phone with a screen display. In general, the mobile terminal 134 may be any mobile device with a display and the television displays 132a, 132b and 132c may be any type of display device, for example a home theatre projector.

In operation, each of a plurality of sections of the video 106 is encrypted with a respective encrypt key from the sequence of encrypt keys 110f to produce the encrypted copy 108f. The encrypted copy 108f and the sequence of encrypt keys 110f are stored by the service provider 128. The encrypted sections of the encrypted copy 108f and respective key-coded decrypt keys are streamed to the media centers 130a, 130b and 130c and the mobile terminal 134 via communication links 118f, 118g, 118h and 118i respectively. The respective key-coded decrypt keys streamed via communication links 118f, 118g, 118h and 118i are respectively coded with identification information relating to each of the media centers 130a, 130b and 130c and the mobile terminal 134 respectively. The media centers 130a, 130b, 130c and the mobile terminal 134 decrypt the sections of the encrypted video 108f with the respective key-coded decryption keys, thereby watermarking the decrypted videos with the identification relating to each of the media centers 130a, 130b and 130c and the mobile terminal 134 respectively. The decrypted videos are then displayed on the television displays 132a, 132b and 132c and on the mobile terminal 134 respectively.

In the example implementation shown in FIG. 5, the decrypted videos are displayed with sub-framing by the television displays 132a, 132b and 132c. In general, the decrypted video may be displayed with or without sub-framing.

While FIG. 5 shows one encrypted video distributed to four download and decryption systems, namely the three set-top boxes 130a, 130b and 130c and the mobile terminal 134, in general any number of videos may be encrypted and streamed to any number of download and decryption systems.

In some implementations, the system shown in FIG. 5 is used in a first mode of operation, in which a consumer pays a per-viewing charge in order to receive the encrypted content and key-coded decryption keys from the service provider. In this first mode of operation, the same encrypted content with different individual key-coded decryption keys are streamed from the service provider to each consumer simultaneously at a scheduled time. Therefore, in the first mode of operation, a consumer may only view the encrypted content at the scheduled time.

In some implementations, the system shown in FIG. 5 is operated in the first mode of operation in order to provide a secure pay-per-view service in which decrypted video content is watermarked by the key-coded decryption keys.

In some implementations, the system shown in FIG. 6 is used in a second mode of operation, which is similar to the first mode of operation, in that the consumer pays a per-viewing charge in order to receive the encrypted content and key-coded decryption keys from the service provider, however, in the second mode of operation, the stream of encrypted content and key-coded decryption keys from the service provider is provided according to a demand from the consumer, rather than at a scheduled time. Therefore, in the second mode of operation, the same encrypted content with different key-coded decryption keys may be streamed from the service provider to different consumers at different times.

In some implementations, the system shown in FIG. 5 is operated in the second mode of operation in order to provide a secure on-demand service in which decrypted video content is watermarked by the key-coded decryption keys.

In the first mode of operation and the second mode of operation, the consumer pays a per-viewing charge to receive encrypted content and associated key-coded decryption keys from the service provider. More generally, any billing schemed may be utilized by the service provider to charge for content delivery. For example, on a time basis, such as on a daily, weekly, monthly or annual subscription basis.

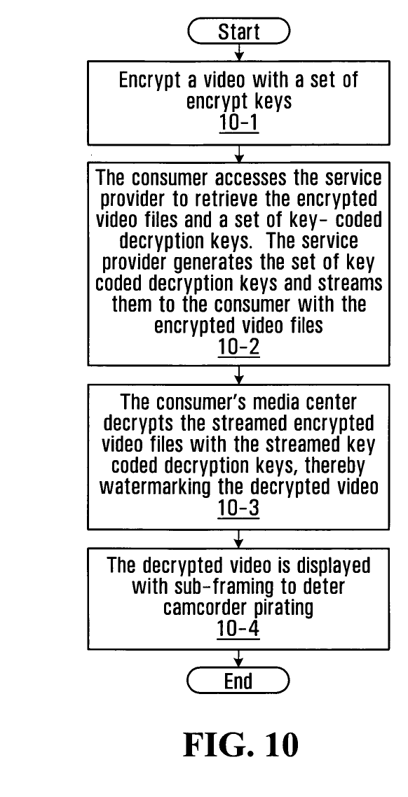

An example of a method of providing copies of videos to video service networks such as cable networks or satellite television networks will now be described with reference to FIG. 10. The method begins at step 10-1, in which a plurality of sections of a video is encrypted with a set of respective encrypt keys. In step 10-2, a consumer accesses the service provider to retrieve the encrypted video files and a set of key-coded decryption keys. The service provider generates the set of key-coded decryption keys and streams them to the consumer with the encrypted video files. In step 10-3, the download and decryption system of the consumer's media center decrypts the streamed encrypted video files with the streamed key-coded decryption keys, thereby watermarking the decrypted video. In step 10-4, the decrypted video is displayed with sub-framing to deter camcorder pirating.

In some implementations, the consumer can save the encrypted content, but each key-coded decrypt key of the sequence of key-coded decrypt keys is deleted after it has served its purpose, i.e. after it has been used to decrypt the corresponding section of the plurality of sections of the encrypted video.

FIG. 6 is a block diagram of another example implementation of a system for distributing encrypted content in a video service network. In this implementation, video contents are encrypted and the encrypted contents are made freely available. The keys are sent to the service providers. Consumers can obtain encrypted videos from file-sharing networks formed by the consumers' download and decryption systems, or in the form of a physical storage medium such as DVDs, which they can duplicate and share freely. To view the videos, consumers provide identification information and pay a per-viewing charge to retrieve the decryption keys from their service providers. The appropriate keys are sent over the Internet in sync with the video. Movies may be viewed on computers, television or video phone. Consumers are charged per viewing. Since the encrypted contents are stored by the consumers' download and decryption systems and distributed via the file-sharing networks formed by the consumers' download and decryption systems, they will be always available anywhere.

The system is secure. It provides end-to-end protection. Service providers retain full control of the viewing process, yet viewers have full control of their viewing experience—able to watch any movie, any time, anywhere and in anyway they prefer; they can even pause and rewind. It is also very cost effective and efficient because viewers do all the heavy lifting—they store and distribute the encrypted contents.

In the example implementation shown in FIG. 6, encrypted copies 108g and 108h of videos 106a and 106b are created with encryption key sets 110g and 110h respectively. The encryption key sets 110g and 110h are stored in an encrypt key storage by a service provider 138, which has communication links with download and decryption systems 148, 150, 152 and 154, which are shown as a set-top box with a built-in DVD player, a personal video recorder, a computer and a mobile terminal respectively. The download and decryption systems 148, 150 and 152 are each functionally connected to a respective display device 149, 151 and 153, while the download and decryption system 154 has a built-in screen display. In general, the download and decryption systems 148, 150, 152 and 154 may be any combination of equipment capable of storing an encrypted video, communicating with the service provider 138 to retrieve decryption keys and capable of decrypting the encrypted video so that the decrypted video may be displayed on a display device.

The communication links between the service provider 138 and the download and decryption systems 148, 150, 152 and 154 are used to download key-coded decryption keys 118j, 118k, 118l and 118m respectively. The download and decryption systems 148 and 150 are shown as downloading the encrypted video 108g and retrieving the key-coded decryption keys 118j and 118k respectively. The key-coded decryption keys 118j and 118k are shown as being generated from the encryption key 110g that was used to encrypt the video 106a into the encrypted video 108g. The download and decryption systems 152 and 154 are shown as downloading the encrypted video 108h and retrieving the key-coded decryption keys 118l and 118m respectively. The key-coded decryption keys 118l and 118m are shown as being generated from the encryption key 110g that was used to encrypt the video 106b into encrypted video 108h.

The encrypted videos 108g and 108h are made available on file-sharing networks 136, which is formed by the download and decryption systems 148, 150, 152 and 154 and respective communication links 140, 142, 144 and 146. In general, the file-sharing networks 136 may have any number of encrypted video files available for download.

In operation, the videos 106a and 106b are encrypted into encrypted videos 108g and 108h respectively, with the encryption key sets 110g and 110h respectively, and the encryption key sets 110g and 110h are stored in an encrypt key storage by a service provider 138. The encrypted videos 108g and 108h are made available to the file sharing networks 136 formed by the download and decryption systems 148, 150, 152 and 154. The file-sharing networks 136 allow the download and decryption systems 148, 150, 152 and 154 to download encrypted content from each other and from other download and decryption systems (not shown) which are connected as part of the file-sharing networks 136. In some implementations, the encrypted videos 108g and 108h are also made available on physical storage mediums such as DVDs. When a user of the download and decryption system 148 wishes to view the video 106a, the user may download the encrypted video 108g via the file sharing networks 136 or obtain a DVD containing the encrypted video 108g. The user then pays a per-viewing charge to access the encrypt key storage of the service provider 138 to obtain the set of key-coded decryption keys 118j, which the service provider generates from the encryption key set 110g. The service provider 138 sends the set of key-coded decryption keys 118j to the user in sync with the video via the communication link with the download and decryption system 148. The download and decryption system 148 decrypts the encrypted video 108g with the key-coded decryption keys 118j, thereby watermarking the decrypted video. The decrypted video is then displayed. The download and decryption systems 150, 152 and 154 operate in the same manner to display decrypted video.

In some implementations, the decrypted videos are displayed with sub-framing.

While FIG. 6 shows two encrypted videos being made available to a file sharing network formed by four download and decryption systems, in general any number of videos may be encrypted and made available to any number of file sharing networks formed by any number of download and decryption systems.

In some implementations, the download and decryption systems 148, 150, 152 and 154 are operable to retrieve encrypted content from each other and from other download and decryption systems (not shown) over the file-sharing network and retrieve streamed encrypted content together with key-coded decryption keys from the service provider, similar to the operation of the system shown in FIG. 5.

Similar to the system shown in FIG. 5, the system shown in FIG. 6 is operable to provide a secure pay-per-view service and a secure on-demand service in which decrypted video content is watermarked by the key-coded decryption keys.

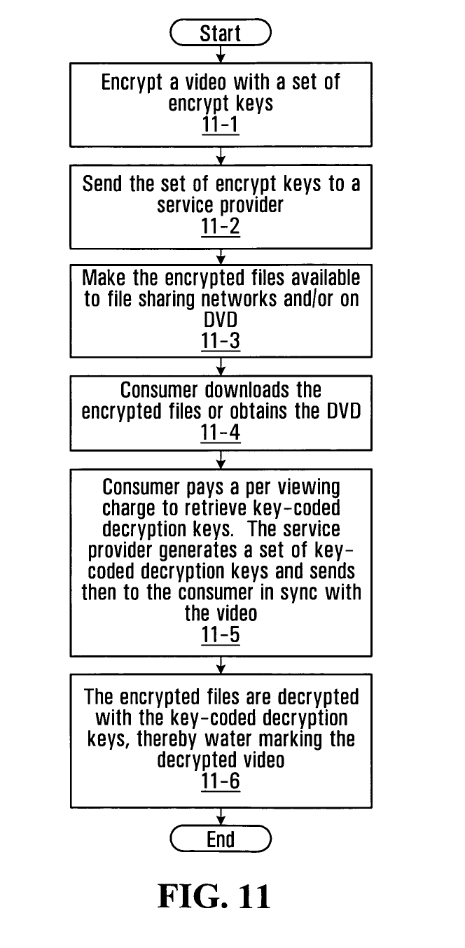

An example of a method of providing copies of videos in a file-sharing pay-per-view service will now be described with reference to FIG. 11. The method begins at step 11-1, in which a video is encrypted with a set of encrypt keys. In step 11-2, the set of encrypt keys are sent to a service provider. In step 11-3, the encrypted video files are made available to file sharing networks and/or are distributed on a physical storage medium, for example, on DVD. In step 11-4, a consumer retrieves the encrypted files by downloading them via the file sharing networks or obtaining the DVD. In step 11-5, the consumer pays a per viewing charge to retrieve a set of key-coded decryption keys. The service provider generates the set of key-coded decryption keys and sends them to the consumer in sync with the video. In step 11-6, the encrypted video files are decrypted with the key-coded decryption keys, thereby watermarking the decrypted video.

In some implementations, the encrypted video files and the key-coded decryption keys are both retrieved over the internet.

In some implementations, the file-sharing networks are formed by communication links between consumers' download and decryption systems so that encrypted content can be transferred between consumers' download and decryption systems.

In some implementations, the decrypted video is displayed with sub-framing to deter camcorder pirating.

Numerous modifications and variations of the present invention are possible in light of the above teachings. It is therefore to be understood that within the scope of the appended claims, the invention may be practiced otherwise than as specifically described herein.

1. A method comprising:
encrypting each of a plurality of sections of a video with a respective encrypt key from a sequence of encrypt keys;
for each encrypt key defining a respective set of at least one decrypt key, at least some of the sets containing at least two decrypt keys of varying perfection
generating a plurality of sequences of decrypt keys that correspond to the sequence of encrypt keys, each sequence comprising a respective decrypt key from each set of at least one decrypt key, the keys from sets containing at least two decrypt keys being selected to encode information specific to that sequence of decrypt keys.

2. The method of claim 1 wherein every set of at least one decrypt key comprises two keys of varying perfection consisting of a perfect key and an imperfect key.

3. The method of claim 1 wherein:
encrypting the video comprises encrypting sign bits of parameters representing the video.

4. The method of claim 1 wherein each section of the video is a group of frames.

5. The method of claim 4 wherein encrypting each group of frames comprises encrypting sign bits of parameters representing the group of frames.

6. The method of claim 1 wherein each key is a bit sequence, and encrypting comprises xoring the bit sequence with bits representing the section of the video.

7. The method of claim 1 wherein the information specific to that set of decrypt keys comprises at least one of end user identification information; cinema identification information; time stamp; IP address, computer ID.

8. The method of claim 1 further comprising decrypting each of the encrypted plurality of sections of the video with a respective decrypt key of one of the sequences of decrypt keys to form a decrypted plurality of sections of the video and displaying the decrypted plurality of sections of the video with sub-framing to prevent analog pirating.

9. The method of claim 1 further comprising streaming one of said sequence of decrypt keys in real time to a receiver for use in reproducing the video.

10. A computer readable medium having computer executable instructions stored thereon implementing the method of claim 1.

11. A system comprising:
an encryptor for encrypting each of a plurality of sections of a video with a respective encrypt key from a sequence of encrypt keys, for each encrypt key there being defined a respective set of at least one decrypt key, at least some of the sets containing at least two decrypt keys of varying perfection;
a key set generator that generates a plurality of sequences of decrypt keys that correspond to the sequence of encrypt keys, each sequence comprising a respective decrypt key from each set of at least one decrypt key, the keys from sets containing at least two decrypt keys being selected to encode information specific to that sequence of decrypt keys.

12. A method comprising:
obtaining an encrypted video comprising a plurality of encrypted video sections each encrypted with a respective encrypt key from a sequence of encrypt keys;
accessing an encrypt key storage to provide identification information;
receiving a key-coded sequence of decrypt keys encoded with information specific to the identification information; and
decrypting each encrypted video section with a respective decrypt key from the sequence of decrypt keys, thereby watermarking the decrypted video.

13. The method of claim 12 further comprising displaying the decrypted video.

14. The method of claim 13 wherein displaying the decrypted video comprises displaying the decrypted video with sub-framing.

15. The method of claim 12 wherein receiving a key-coded sequence of decrypt keys comprises receiving the key-coded sequence of decrypt keys by key-streaming.

16. The method of claim 12 wherein obtaining an encrypted video comprises obtaining the encrypted video by any one of:
downloading the encrypted video over a file-sharing network;
receiving a stream comprising the plurality of encrypted video sections and the key-coded sequence of decrypt keys; and
obtaining a physical storage medium on which the encrypted video is recorded.

17. The method of claim 12 further comprising paying a per-viewing charge prior to receiving the key-coded sequence of decrypt keys.

18. The method of claim 12 wherein the information specific to the identification information comprises at least one of end user identification information; cinema identification information; time stamp; IP address, computer ID.

19. Video decryption apparatus operable to carry out the method of claim 12.

20. A video decryption system comprising:
an encrypted video storage operable to store an encrypted video comprising a plurality of encrypted video sections each encrypted with a respective encrypt key from a sequence of encrypt keys; and
a decryptor functionally connected to the encrypted video storage and operable to:
access an encrypt key storage to provide identification information;
receive a key-coded sequence of decrypt keys encoded with information specific to the identification information; and
decrypt each encrypted video section with a respective decrypt key from the sequence of decrypt keys, thereby watermarking the decrypted video.

21. A previewer video decryption system comprising:
the video decryption system of claim 20, wherein the encrypted video storage comprises any one of a DVD, a hard drive and a memory.

22. The previewer video decryption system of claim 21 wherein the decryptor is operable to receive the key-coded sequence of decrypt keys by key-streaming.

23. The previewer video decryption system of claim 22 further comprising display equipment functionally connected to the decryptor and operable to display the decrypted video with sub-framing.

24. A digital cinema video decryption system comprising:
a digital projector;
a cinema server; and
a screen controller, wherein the screen controller is functionally connected to the digital projector and comprises the video decryption system of claim 20, and wherein the cinema server is functionally connected to the screen controller and is operable to receive an encrypted video and send the encrypted video to the screen controller.

25. The digital cinema video decryption system of claim 24, wherein the screen controller is operable to receive the key-coded sequence of decrypt keys by key-streaming.

26. The digital cinema video decryption system of claim 25, wherein the screen controller and the digital projector are operable to display the decrypted video with sub-framing.

27. A video service network video decryption system comprising:
the video decryption system of claim 20, wherein the video service network video decryption system is operable to receive the key-coded sequence of decrypt keys by receiving a stream comprising the key-coded sequence of decrypt keys and the plurality of encrypted video sections from a service provider.

28. The video service network video decryption system of claim 27, wherein the video service network video decryption system deletes each decrypt key of the key-coded sequence of decrypt keys after the decrypt key has been used to decrypt a corresponding section of the plurality of encrypted video sections.

29. The video service network video decryption system of claim 28 wherein the video decryption system comprises any one of a mobile terminal with a screen display and a set-top box.

30. The video service network video decryption system of claim 29 wherein the set-top box has a built in DVD player.

31. The television network video decryption system of claim 28 wherein the video decryption system is operable to display decrypted video with sub-framing.

32. A video service network video decryption system comprising:
the video decryption system of claim 20, wherein the video service network video decryption system forms part of a file-sharing network, wherein the video service network video decryption system is operable to share the encrypted video across the at least one file-sharing network with other video service network video decryption systems which are part of the file-sharing network.

33. The video service network video decryption system of claim 32 wherein the video service network video decryption system comprises any one of a mobile terminal with a screen display, a DVD player, a personal video recorder, and a computer.

34. The video service network video decryption system of claim 32 wherein the video service network video decryption system is operable to receive the key-coded sequence of decrypt keys by key-streaming.

35. The video service network video decryption system of claim 34 wherein the video service network video decryption system is operable to display decrypted video with sub-framing.

36. The video service network video decryption system of claim 32 further operable to receive the key-coded sequence of decrypt keys by receiving a stream comprising the key-coded sequence of decrypt keys and the plurality of encrypted video sections from a service provider.
